(19) United States
(12) Patent Application Publication
(10) Pub. No.: US 2006/0130663 A1
(43) Pub. Date: Jun. 22, 2006

(54) System and method of air quality control for air-conditioning devices

(75) Inventors: Anand Ganesh Joshi, Bangalore (IN); Mark Wayne Wilson, Simpsonville, KY (US); Gautam Subbarao, Louisville, KY (US); Hemachandran Umakanthan, Cuddalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/017,608

(22) Filed: Dec. 20, 2004

(51) Int. Cl. B01J 19/08; B01D 46/00

(52) U.S. Cl. 96/224; 422/186.2

(57) ABSTRACT

A system and method for air quality control system for an air-conditioning device. The air quality control system includes a housing having an inlet end to receive a source airflow from the air-conditioning unit and an outlet end to provide a sanitized airflow. The system also includes a number of independently controllable air sanitizing components coupled to the housing. The system further includes a controller to adaptively control which of the air sanitizing components should operate as a function of at least an operating state of the air conditioning unit.

### BACKGOUND

Embodiments of the present invention relate generally to air conditioning and air cleaning, and more particularly to a system and method for controlling the quality of air emitted from air conditioning devices.

Controlling quality of air emitted by air conditioning devices is important because a significant part of world population today lives under the threats of chronic lung diseases such as asthma and chronic bronchitis, which are caused by airborne pathogens. Moreover, there is ever increasing risk of bio-terrorism and infections from microbe-infested indoor air. Furthermore, although bacteria and microbes present in the air may be killed by ultraviolet irradiation from the germicidal lamps, such radiation does not help in controlling or reducing foul odors in the indoor air.

Traditional air purifiers found in the prior art are typically stand-alone fan-units fitted with devices like germicidal lamps that are positioned in the recirculation air path of the fan-units. These air purifiers are independent units and do not work in sync with room air-conditioners/dehumidifiers. This makes purification of a large volume of air difficult without the use of multiple purification units. Air purification in a hotel with a large number of rooms, for example, would require the use of a large number of such traditional air purifiers, which can easily translate into a very high cost. Moreover, such traditional air purifiers require additional space, electrical power and human intervention/manual operation and control, which may not be suitable for many situations.

Thus, there is need of an air quality control system that better treats the air from air conditioning devices.

### BRIEF DESCRIPTION

Briefly, in accordance with another embodiment of the invention, there is provided a modular air quality control system for use with an air-conditioning unit. The air quality control system includes a housing having an inlet end to receive a source airflow from the air-conditioning unit and an outlet end to provide a sanitized airflow. The system also includes a number of independently controllable air sanitizing components coupled to the housing. The system further includes a controller to adaptively control which of the air sanitizing components should operate as a function of at least an operating state of the air conditioning unit.

In accordance with one embodiment of the invention, there is provided an air quality control system for an air-conditioning device. The system includes at least one germicidal lamp configured to emit ultraviolet radiation within an airflow of the air-conditioning device, an at least one ozone lamp configured to emit ozone gas within the airflow and a controller, responsive to the airflow that controls quality of air within the airflow as a function of ultraviolet radiation and ozone gas. In one embodiment, the air quality control system is electrically isolated from the air-conditioning device.

In accordance with another embodiment of the invention, there is provided a method for air quality control for an air-conditioning device. The method includes generating ultraviolet radiation within airflow of the air-conditioning device, generating ozone gas within the airflow and controlling the quality of air within the airflow in response to the airflow as a function of ultraviolet radiation and ozone gas.

### DRAWINGS

FIG. 1 is a diagram of an air quality control system constructed in accordance with one embodiment of the invention.

FIG. 2 is a schematic diagram of an air quality control system of FIG. 1 constructed in accordance with one embodiment of the invention.

FIG. 3 is a schematic diagram of a simplified control circuit of the air quality control system of FIG. 1 constructed in accordance with one embodiment of the invention.

FIG. 4 is a schematic diagram of an air quality control system of FIG. 1 constructed in accordance with another embodiment of the invention.

FIG. 5 illustrates one embodiment of a method for air quality control.

### DETAILED DESCRIPTION

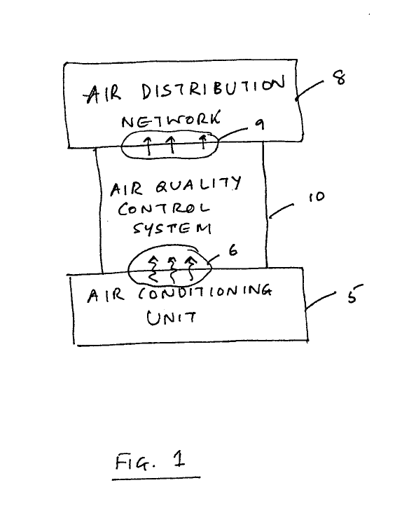

FIG. 1 illustrates an air quality control system 10 in accordance with one embodiment of the invention. In the illustrated embodiment, the air quality control system 10 is disposed between a conventional air conditioning unit 5 and a conventional air distribution network 8. In the description and claims to follow and unless otherwise indicated, the terms air conditioning unit, air conditioning device, and air conditioning system are intended to be synonymous and may be used interchangeably herein. Furthermore, such terms are intended to represent a broad class of devices, including but not limited to air coolers, air heaters, dehumidifiers, and humidifiers that operate to condition air. The air distribution network 8 may represent a conventional air airflow cabinet designed for use with the air conditioning unit 5 to distribute and/or direct conditioned air to one or more locations or objects. In one embodiment of the invention, the air quality control system 10 represents a modular, self-contained system designed to receive a source airflow 6 from the air conditioning unit 5, adaptively sanitize the source airflow, and provide the sanitized airflow 9 to the air distribution network 8. To that end, although there may be a physical connection between the air conditioning unit 5 and the air quality control system 10, they are mechanically and electrically independent from each other. That is, there is no electrical or mechanical output of power or force(s) from the air conditioning unit 5 going as input to the air quality control system 10 or vice versa. At the same time, although the air quality control system 10 and the air conditioning unit 5, for instance, may share a physical interface, this interface is used for mounting and/or positioning purposes.

In one embodiment, the air quality control system 10 may sanitize the source airflow 6 through the controlled operation and application of a number of air sanitizing components. In one embodiment, the air sanitizing components may include one or more germicidal lamps that irradiate ultraviolet radiation and/or one or more ozone lamps that emit ozone. In one embodiment, operation of such germicidal and/or ozone lamps may be independently controlled such that the amounts of ultraviolet radiation and ozone emitted can be dynamically adjusted. In another embodiment, the air sanitizing components may include a silver zeolite coating on the inner surface of the air quality control system 10 that naturally emits silver ions to kill microbes and bacteria. In yet another embodiment, the air sanitizing components may include a multi-layer ‘High efficiency particulate air’ (HEPA) filter to capture most of the odors, dust, pollen, pet dander and other allergens from the air. In another embodiment, the independently controllable air sanitizing component may be a source of high intensity ultraviolet pulses. The very high intensity pulses of ultraviolet radiation (typically in the range of 0.5 W/cm2) kill most of the airborne bacteria, viruses and fungal spores.

The air quality control system 10 may include combinations of air sanitizing components and may not be limited to those described above. More specifically, in one embodiment, the air quality control system 10 may utilize a combination of one or more lamps, one or more sensors and one or more controllers in a feedback relationship to facilitate air quality control that is adaptive to varying rates of source airflow 6. Moreover, in one embodiment, the air quality control system 10 may further include a user interface through which a user may customize various aspects of the internal environment of air quality control system 10.

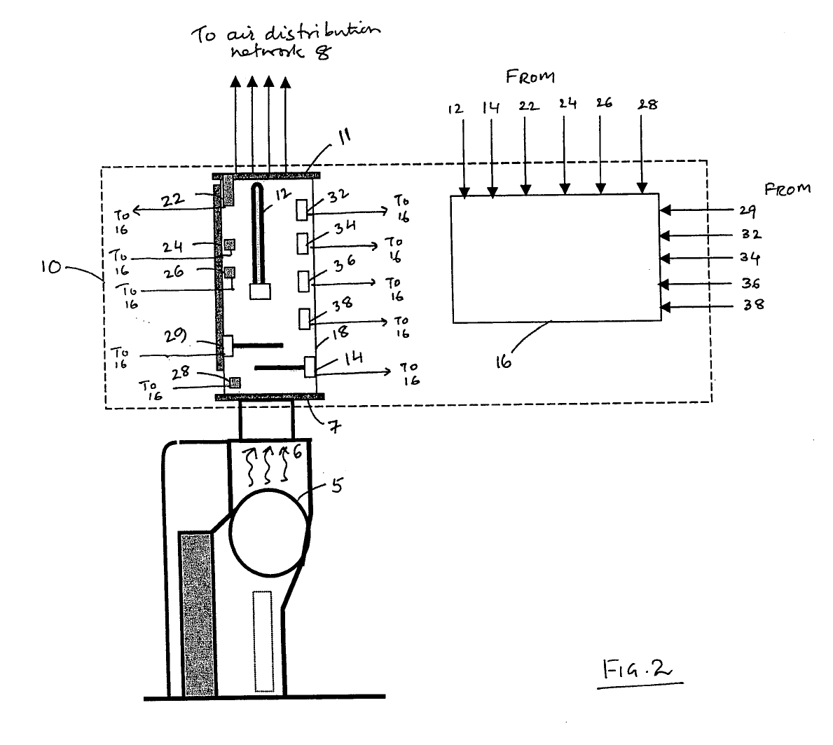

FIG. 2 is a schematic diagram of the air quality control system 10 of FIG. 1 constructed in accordance with one embodiment of the invention. In the illustrated embodiment, air quality control system 10 includes a housing 18 having an air inlet end 7 to receive a source airflow 6 from air conditioning unit 5, and an air outlet end 11 to provide a sanitized airflow 9 to air distribution network 8, for example. In the illustrated embodiment, the air quality control system 10 further includes one or more germicidal lamps 12 coupled to the housing 18. Germicidal lamp(s) 12 emit ultraviolet radiation to kill germs and microbes inside the housing 18. In another embodiment, the air quality control system 10 may include one or more ozone lamps 14 coupled to the housing 18. The ozone lamp(s) 14 emits ozone gas to kill additional germs and microbes inside the housing 18 and to oxidize particles suspended in the air of the housing 18. The air quality control system 10 may further include an ozone sensor 22, an ultraviolet radiation sensor 24, an odor sensor 26, an airflow sensor 28 and an air switch 29. Ozone sensor 22 may operate to determine the quantity of ozone within the housing 18 while the ultraviolet radiation sensor 24 may operate to determine the quantity of ultraviolet radiation within the housing 18. Additionally, the odor sensor 26 may operate to sense odor levels within housing 18 while the airflow sensor 28 may operate to sense aspects of source airflow 6 from the air conditioning unit 5. For example, the airflow sensor 28 may continuously measure air velocity or volumetric flow rate of source airflow 6 inside the housing 18, while the air switch 29 may detect the operating state of air conditioner 5 based upon the presence or absence of source airflow 6.

In the illustrated embodiment, the air quality control system 10 also includes a controller 16 that controls or may otherwise influence the overall operation of the air quality control system 10. In one embodiment, the controller 16 is communicatively coupled to one or more components of the air quality control system 10, including but not limited to the ozone lamp(s) 14, the germicidal lamp(s) 12, the ultraviolet radiation sensor 24, the odor sensor 26, the airflow sensor 28, as well as interlock switches 32 and 34 (to be discussed in further detail below). The controller 16 may be physically collocated with such components (whether inside or outside of the housing 18), or the controller 16 may be located remote from the housing 18. Moreover, the controller 16 may communicate with one or more components of the air quality control system 10 via wired or wireless communication links.

The controller 16 may operate to monitor the operational status of the germicidal and ozone lamp(s) (12, 14) within the air quality control system 10. In particular, the controller 16 may monitor the operational status of the germicidal lamp(s) 12 with the help of e.g. the germicidal lamp status indicator 36 and monitor the operational status of the ozone lamp(s) 14 with the help of e.g. the ozone lamp status indicator 38. The germicidal lamp status indicator 36 and the ozone lamp status indicator 38 may be visual, audio or audio-visual signaling devices that indicate a proper or faulty operating status of the germicidal lamp(s) 12 and the ozone lamp(s) 14, respectively. In one embodiment, controller 16 dynamically controls levels of ozone, ultraviolet radiation and odors in the air quality control system 10 as a function of the operating state of air conditioning unit 5, the ozone level within the system, the ultraviolet radiation level within the system, and/or the odor level within the system. In one embodiment, the operating state of air conditioning unit 5 may be determined based at least in part upon the presence or absence of the source airflow 6 from the air conditioning unit 5. Similarly, the ozone, ultraviolet radiation and the odor levels may be determined via the ozone sensor 22, the ultraviolet radiation sensor 24 and the odor sensor 26, respectively.

In one embodiment, the germicidal lamp(s) 12 may represent one or more short wave low pressure mercury lamps with a quartz bulb (not shown). The lamp(s) may be used to emit ultraviolet radiation at the resonance wavelength of mercury, e.g. 254 nanometers (nm), which corresponds to the region of maximum germicidal effectiveness and is highly lethal to virus, bacteria and mold spores. Ultraviolet radiation of this wavelength has the ability to kill most of the common microorganisms with which it comes in contact. Moreover, in addition to killing microbes, at this particular wavelength, ultraviolet radiation converts unused and excess ozone present in the air, if any, back to oxygen. Thus in one embodiment the germicidal lamp(s) 12 may convert excess ozone within the housing 18 into oxygen. The germicidal lamp(s) 12 may come in a wide range of glass types, diameters, bases and shapes.

The germicidal lamp(s) 12 of the system 10 is(are) not limited to the above-described configuration. In one embodiment of the invention, the germicidal lamp(s) 12 may contain a coil filament that starts substantially instantaneously and is suitable for applications requiring high ultraviolet intensity. In another embodiment of the invention, the germicidal lamp(s) 12 may represent one or more cold cathode germicidal lamps that start substantially instantaneously and maintains a high ultraviolet transmission even at reduced temperatures. In another embodiment of the invention, the germicidal lamp(s) 12 may be a preheat type operated by a preheat-start circuit. A preheat type of germicidal lamp however usually requires a slight to moderate delay before starting. In one embodiment, the controller 16 communicates with the germicidal lamp(s) 12 to determine intervals and quantity of ultraviolet radiation to be generated. In one embodiment, controller 16 controls the number of germicidal lamps 12 that are switched ‘ON’ at any given time as well as the duration for which they are switched ‘ON’.

The ozone lamp(s) 14 is(are) used to generate ozone gas for treating the air inside the air quality control system 10 and in particular, inside the housing 18. Generation of ozone and/or ultraviolet radiation can be used to retard and/or kill mold spores and other microbes that can render the quality of air inside the air quality control system 10 poor. More specifically, ozone kills bacteria, clears away foul smells and keeps the air fresh by oxidizing and disintegrating volatile organic compounds (VoC) such as glucose oxidase and dehydrogenation oxidase. In one embodiment, one or more ozone lamps may be used to generate the ozone. In operation, the ozone lamp(s) 14 may utilize the photochemical reaction of oxygen under shortwave of wavelength 185 nanometer (nm) ultraviolet rays to produce a continuous flow of ozone. In one embodiment, the controller 16 controls the quantity and the interval of ozone generation by controlling directly or indirectly the number of ozone lamps 14 that are switched ‘ON’ at any given time as well as the duration for which they are switched ‘ON’.

The ozone lamp(s) 14 may be embodied in several ways and is not limited to the above-described configuration. For example, in various embodiments of the invention, the ozone lamp(s) 14 may represent one or more high voltage ozone ionizers. An ozone ionizer typically uses a first process to produce negative ions and another to produce ozone. Negative ions are electrically charged particles that attach themselves to airborne particulates through a process known as ionization. Ionization makes the particulates heavier than the surrounding air, causing them to drop and fall to the ground. Ozone on the other hand is a form of oxygen, which has been electrically energized; making it chemically more active than oxygen. Ozone, being a powerful oxidizing (or odor removing) agent, attaches to airborne pollutants, and through the process of oxidization, breaks down the molecular structure and neutralizes or destroys the odor producing pollutant particles. In one embodiment, these two processes act in concert with one another to clean and purify the air inside the air quality control system 10.

Referring back to FIG. 2, in one embodiment, the ozone sensor 22 senses the ozone level present in the air inside the housing 18. In the course of operation of the air quality control system 10, when the ozone level reaches a determined level, the controller 16 may operate to turn off at least one ozone lamp 14 to keep the level of ozone within the housing 18 at or below the determined level. The generally accepted levels of ozone recommended for air purification are between 0.01 parts per million (ppm) and 0.05 ppm, while the human nose typically begins to detect the smell of ozone around 0.01 ppm. In one embodiment, an ozone meter (not shown) may be coupled to the ozone sensor 22 to display ozone levels in the form of an easy to read multi-colored bar graph for example.

Referring to FIG. 2 again, the ultraviolet radiation sensor 24 monitors the ultraviolet radiation level within housing 18. In one embodiment, an ultraviolet radiation monitor coupled to the ultraviolet radiation sensor 24 measures ultraviolet irradiance and produces a calibrated output that can be read e.g. by a powerline communication (PLC) device or any other device allowing the display of absolute irradiance levels in e.g., units of μW/cm2 or in percentage values. In one embodiment, the ultraviolet radiation sensor 24 is mounted inside the housing 18 in the path of the source airflow 6 to monitor the level of ultraviolet radiation within the housing 18. In one embodiment, the ultraviolet radiation sensor 24 is tuned to measure only the 254 nm wavelength, however other wavelengths could be measured. The ultraviolet radiation sensor 24 may supply a current or voltage signal proportional to the amount of ultraviolet radiation sensed to a display meter (not shown). In one embodiment, the ultraviolet radiation sensor 24 is communicatively coupled to the controller 16. In the course of operation of the air quality control system 10, when the level of ultraviolet radiation within the housing 18 reaches a determined level, the controller 16 may operate to turn off at least one ultraviolet lamp 12 to keep the level of ultraviolet radiation within the housing 18 at or below the determined level.

Often, the production of offensive odors in air conditioning systems can be traced to the build-up of certain types of microorganisms or chemical odors, vapors or gases inside the air conditioning unit 5. In one embodiment, the odor sensor 26 is coupled to housing 18 and is used to sense the odor inside the housing 18. The odor sensor 26 may measure the density or concentration of odor emitting components, such as HC, CO, NOx, and CO2 gases extricating in the air quality control system 10. In one embodiment of the invention, the odor sensor 26 sends one or more signals representing the odor levels in the air quality control system 10 to the controller 16.

In an alternative embodiment, the odor sensor 26 may be a combination of electronic chemical sensors, which are commonly referred to as “electronic noses”. Electronic noses typically work by comparing process signals from a sensor array with known patterns stored in a database. Various types of sensor arrays may include conductive polymer sensors, metal oxide conductivity sensors, quartz resonator type sensors, polymer dielectric sensors (capacitor), and fluorescent optical sensors. In another embodiment, electrical circuits of various embodiments may include at least one odor-sensitive organic transistor having a conduction channel whose conductivity changes in response to odors present in the environment.

Along with ozone, ultraviolet radiation and odor levels, another parameter that may be closely monitored for effective treatment of air in the air quality control system 10 is the airflow inside housing 18. In one embodiment, the source airflow 6 inside the housing 18 is monitored using the airflow sensor 28 and the air switch 29 as mentioned earlier. The airflow sensor 28 may operate to sense aspects of the source airflow 6 such as air velocity or volumetric flow rate from the air conditioning unit 5. The air switch 29 on the other hand, may detect the operating state of air conditioner 5 based upon the presence or absence of source airflow 6. In one embodiment, once source airflow 6 reaches at least a minimum flow rate, the air switch 29 activates (e.g., completes a circuit) causing the air quality control system 10 to become operative. In one embodiment, controller 16 determines the operational state of the air conditioning unit 5 (e.g., whether or not the air conditioning unit 5 is in a powered ‘ON’ state) based on the presence or absence of the source airflow 6 as e.g. determined by the air switch 29.

The airflow sensor 28 may measure air velocity or volumetric flow rate of air inside the housing 18 using, for example, an insertion probe (not shown) or a capture hood (not shown). In one embodiment, the airflow sensor 28 may be positioned inside the air quality control system 10 to measure air velocity. In this instance, differential pressure type sensors may use Pitot tubes, averaging tubes and other velocity pressure measurement devices to sense the airflow. In other instances a capture hood may be used to measure volumetric flow from a grill or an exhaust diffuser. In one embodiment, the airflow sensor 28 communicates with the controller 16 to sense airflow levels inside the air quality control system 10. The airflow sensor 28 of the system 10 may be embodied in several ways and is not limited to the above-described configuration. For example, a thermal anemometer may also be used to sense airflow. A thermal anemometer is a device that is heated up to a fixed temperature and then exposed to the air velocity. By measuring how much more air is required to maintain the original temperature, an indication of the air speed is gained. The higher the air speed, the more energy that is required to keep the temperature at a set level. In yet a further embodiment, vane anemometers may be positioned in the air path to measure the source airflow 6. Vane anemometers typically have proximity switches that count the revolutions of the vanes and supply a pulse sequence that is converted by the measuring instrument into a flow rate.

In one embodiment, the controller 16 determines and programmatically turns ON a required number of germicidal lamp(s) 12 or ozone lamp(s) 14 based on the value of the airflow rate sensed by the airflow sensor 28. For instance, when the airflow rate sensed by the airflow sensor 28 is higher than a standard operative range of values for airflow rate, the controller 16 may determine that the microbial load of the air is also higher than a standard operative range of values for microbial load. In that instance, in order to treat to the higher-than-standard microbial load, the controller 16 may programmatically turn ON a greater number of germicidal lamp(s) 12 or ozone lamp(s) 14 more in number than would otherwise be necessary for a standard airflow rate. In another instance, if the airflow rate sensed by the airflow sensor 28 is less than a standard value of airflow rate, the controller 16 may determine that the microbial load of the air is also less than a standard operative range of values for microbial load. In this instance again, in order to treat to the less-than-standard microbial load, the controller 16 may programmatically turn OFF some of the germicidal lamp(s) 12 or ozone lamp(s) 14 that would otherwise be necessary for a standard airflow rate.

In another embodiment, the air switch 29 senses the source airflow 6 and provides an additional functionality of switching ON the germicidal lamp(s) 12 and ozone lamp(s) 14 when the source airflow 6 exceeds a determined threshold value. In one embodiment, the air switch 29 includes a mechanical lever type micro-switch (not shown) and an air flap (not shown). The air flap may be positioned across the airflow inside the housing 18 such that it is pushed by the flowing air at the minimum designed airflow of the air conditioning device 5. The air flap senses the pressure caused by the flow of the air. The micro-switch and the air flap are coupled in such a way that when the air flap senses the airflow to be more than a threshold value, the state of the micro-switch is changed and it sends an electrical signal to the controller 16. The controller 16 detects the signal and switches ON the germicidal lamp(s) 12 and ozone lamp(s) 14. In operation, the air switch 29 enables synchronization of the air quality control system 10 with the air-conditioning device 5 without any electrical or mechanical connectivity between them.

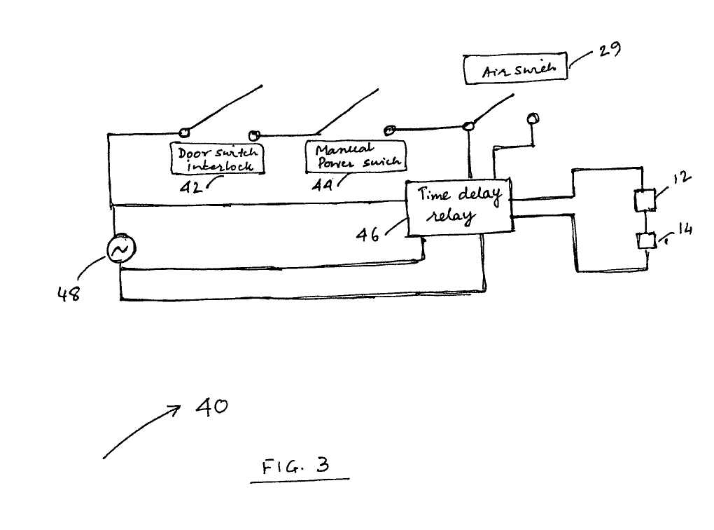

FIG. 3 is a schematic diagram of a simplified control circuit 40 of the air quality control system 10 of FIG. 1 constructed in accordance with one embodiment of the invention. As illustrated in FIG. 3, in addition to the air switch 29, the control circuit 40 includes a door switch interlock 42 that provides desired safety to a user of the air quality control system 10. In one embodiment, the door switch interlock 42 breaks the control circuit 40 when the access door (not shown) of the system 10 is opened. In one embodiment, the control circuit 40 may include a manual power switch 44 for manually powering the air quality control system 10 ON or OFF. In operation, the control circuit 40 is completed when each of the air switch 29, the door switch interlock 42 and the manual power switch 44 is in the ON position. Upon the control circuit 40 being completed, a time delay relay 46 is triggered and a power source 48 for the germicidal lamp(s) 12 and the ozone lamp(s) 14 is activated. The time delay relay 46 keeps the germicidal lamp(s) 12 or the ozone lamp(s) 14 ON for a determined period of time. This way, the time delay relay 46 prevents the germicidal lamp(s) 12 or the ozone lamp(s) 14 from turning OFF at every cycle of the air conditioning device 5 and thereby helps increasing the working life of the germicidal and ozone lamps 12 or 14. In the illustrated embodiment, the power source 48 for the germicidal lamp(s) 12 and the ozone lamp(s) 14 is disconnected when the status of any one or more of the air switch 29, the door switch interlock 42 and the manual power switch 44 changes to OFF position.

Referring back to FIG. 2, the controller 16 controls and coordinates the environmental management of the air quality control system 10. The controller 16 may represent hardware circuitry, software, or a combination thereof. More specifically, the controller 16 may include, but is not limited to a range of devices, such as a microprocessor based module, an application-specific or general purpose computer, a programmable logic controller or a logical module, solid-state equipment, relays as well as appropriate programming code for performing computations associated with air quality control within the air quality control system 10.

In accordance with one embodiment of the invention, the controller 16 includes logic for activating a suitable number of ozone lamps 14 in coordination with sensing signals from the ozone sensor 22. In this instance, the ozone sensor 22 determines the ozone level inside the housing 18 and sends a corresponding signal to the controller 16. The controller 16 in turn switches ‘ON’ or ‘OFF’ a sufficient number of ozone lamps 14 based on the ozone level sensed inside the housing 18 and as determined by its preset logic. In a similar manner, the controller 16 may also include logic for activating/deactivating a suitable number of germicidal lamps 12 in coordination with sensing signals received from the ultraviolet radiation sensor 24 to maintain the ultraviolet radiation level inside the housing 18 within a range that is predetermined for the given airflow rate. In this instance, the ultraviolet radiation sensor 24 determines the ultraviolet radiation level inside the housing 18 and sends a corresponding signal to the controller 16. The controller 16 in turn switches ‘ON’ or ‘OFF’ a sufficient number of germicidal lamps 12 based on the ultraviolet radiation level sensed inside the housing 18, airflow sensed by the airflow sensor 28 and as determined by its preset logic. Similarly, the controller 16 may monitor and control the odor level inside the housing 18 via sensing signals received from the odor sensor 26 to detect whether the odor level goes beyond an acceptable range as is later described in further detail.

In another embodiment of the invention, the controller 16 further activates appropriate alerts if a determined level of ozone or ultraviolet radiation or odors is exceeded. Similarly, the controller 16 may activate appropriate alerts if a detected level of ozone or ultraviolet radiation falls below a determined or preset level. The command signals issued by the controller 16 may approximate a binary decision process wherein proper and improper levels or ranges are differentiated. Alternatively, more robust information may be obtained and processed depending upon the type of situation being monitored, the sophistication of the sensors involved and the logic of the controller 16.

In operation, any one or more of the parameters such as ultraviolet radiation level, ozone level (e.g., expressed in parts per million), and odor level may be monitored and controlled by the controller 16. The controller 16 operates such that the air quality control system 10 remains within determined ranges of operation for these parameters.

The air quality control system 10 may further include interlock switches to safeguard against potentially dangerous failures or other events involving important devices or sensors. In the illustrated embodiment of FIG. 2, the air quality control system 10 includes interlock switches 32 and 34. In one embodiment, interlock switch 32 may interrupt operation of the germicidal lamp(s) 12 when the ultraviolet radiation sensor 24 fails, whereas interlock switch 34 may interrupt operation of the ozone lamp(s) 14 if the ozone sensor 22 fails. Interlock switches 32 and 34 may be electrical, mechanical or optical based switches.

In operation, the interlock switches 32 and 34 may interrupt the operation of the controller 16 in time of a power failure or other event. Interlock switches 32 and 34 may include discrete hardware to complement or back-up operation of the controller 16 during failures. Embodiments of the invention are not limited to the above-described functionalities of the interlock electronics. There are many other operations such as activating audio and/or video warning indicators that can be performed by the interlock electronics during a failure of the air quality control system 10 or its components.

In one embodiment, the controller 16 may initiate various control cycles including an ozone cycle, an odor cycle and an ultraviolet radiation cycle, each of which may be executed or performed sequentially or in parallel with respect to the others. During the ozone control cycle, ozone may be generated (e.g., via ozone lamp(s) 14) in the housing 18 in a continuous mode to adaptively maintain a desired level of ozone in a continuous fashion. Alternatively the ozone may be generated in a “dosage” form wherein the ozone source may be turned ON at intervals for a certain length of time until the desired ozone level is reached. The ozone dosage may be determined as a function of the dosage level and dosage frequency (number of dosage cycles per day). Ozone levels may be reduced in a number of ways. In one instance, operation of the ozone lamp(s) 14 may be stopped so as to allow accumulated excess ozone to decay naturally. In another instance, an ‘auto de-ozonization’ process performed in the air quality control system 10 allows excess ozone within housing 18 to be converted back into oxygen thereby reducing the chance of exposure to ozone by individuals. The term ‘auto de-ozonization’ as used herein refers to an automatic removal of excess ozone with the help of ultraviolet radiation. In one embodiment, in addition to killing microbes, ultraviolet radiation emitted from the germicidal lamp(s) 12 at a wavelength of 254 nm provides the additional functionality of reducing the accumulated excess ozone into oxygen. In yet another instance, heating elements may be used with the air quality control system 10 to heat the air inside the housing 18 and act to convert the accumulated excess ozone into oxygen.

In a similar manner, during the odor control cycle, odors within source airflow 6 may be reduced by the air quality control system 10 to maintain the desired level of odors at a non-increasing steady-state level. Odor may be removed by generating ozone with the help of the ozone lamp(s) 14 as elaborated earlier. The controller 16 may include timing mechanisms that activate time-based controls of the ozone lamp(s) 12. The switching of one or more ozone lamps 12 ON generates ozone that in turn acts to reduce the odor causing volatile organic compounds. The ON/OFF time of the ozone lamp(s) 12 may vary depending upon the airflow, ultraviolet radiation levels and odors present in the air quality control system 10. The odor sensor 26 is placed in the air quality control system 10 to monitor the odor type and level in the air from the air conditioning unit 5 and to adaptively control the ozone generation. The controller 16 may monitor the odor level inside the air quality control system 10 via sensing signals received from the odor sensor 26 to detect whether the odor level goes beyond an acceptable range. In this instance, based on the odor level sensed inside the air quality control system 10, the controller 16 directly or indirectly switches ‘ON’ or ‘OFF’ a sufficient number of ozone lamps 14 to treat the air for removal of odor as determined by its preset logic.

In a similar manner, the ultraviolet radiation in the air quality control system 10 may be maintained during the ultraviolet radiation cycle. This may be accomplished by increasing or reducing the ultraviolet radiation inside the housing 18, depending for instance, upon a determined set-point and the actual ultraviolet radiation level in the housing. The ultraviolet radiation level in the housing 18 may be increased by programmatically turning ‘ON’ one or more germicidal lamps 12 in the air quality control system 10 by the controller 16 depending upon the determined set-point. There may be different control parameters for different embodiments of the germicidal lamp 12 such as a lamp with coil filament, a lamp with cold cathode or a lamp of preheat types. On the other hand, the ultraviolet radiation level in the air quality control system 10 may be reduced by programmatically turning ‘OFF’ one or more germicidal lamp(s) 12 in the air quality control system 10 by the controller 16

In one embodiment, time based interlock 32 may be added into the control circuit of germicidal lamp(s) 12 to interrupt the ultraviolet radiation generation after a preset time in case the ultraviolet radiation sensing or air sensing fails. Similarly, time based interlock 34 may be added into the control circuit of ozone lamp(s) 14 to interrupt the ozone generation after a preset time in case the ozone sensing fails. As described earlier, the adaptive controller 16, in coordination with the sensors, the optical switches and the interlock switches, may determine, interpret and control the status of the air quality control system 10.

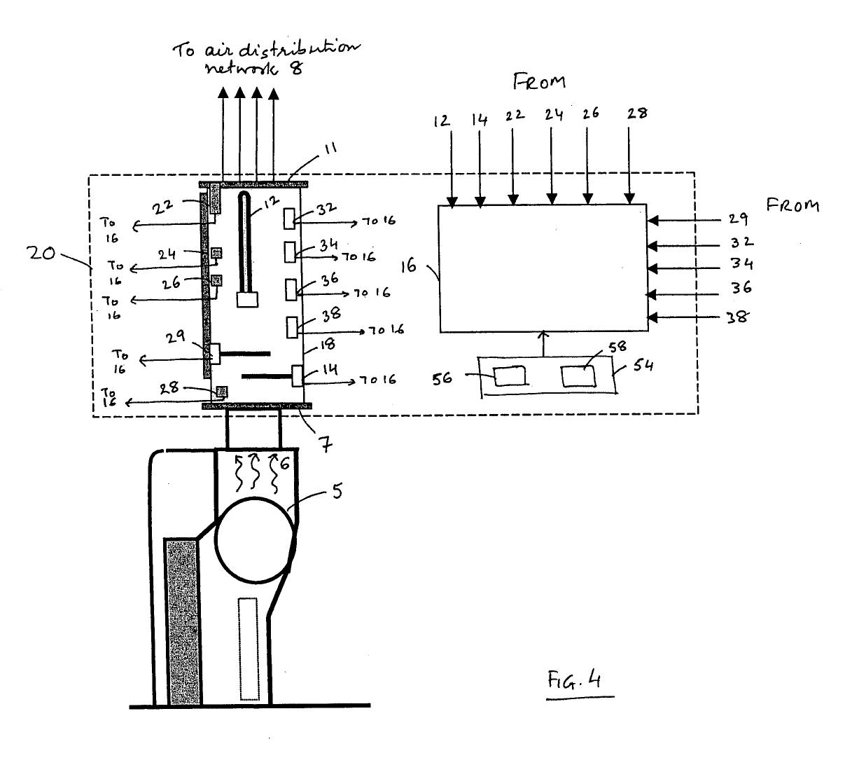

FIG. 4 is a simplified schematic diagram of an exemplary system 20 including air quality control system 10 in accordance with a second embodiment of the invention. In FIG. 4, the system 20 includes the air quality control system 10 that has been enhanced by the addition of a user interface 54. The user interface 54 is communicatively coupled to the controller 16 to provide user input to controller 16. The user input may include various user driven selections such as the number of germicidal lamps 12 and ozone lamps 14 to be activated in a particular operating cycle of the air quality control system 10 as well as various operating modes of the air quality control system 10. User interface 54 may include a display unit 56 and input device(s) 58. In certain embodiments, display unit 56 may be an LCD or touch screen display that can both display and receive information. The display unit 56 may also visually confirm to the user that the desired user input has indeed been entered into the system correctly. In another instance, the display unit 56 may display other operational data such as odor and/or ultraviolet radiation, ultraviolet intensity, lamp status, lamp running (e.g., “ON”) hours, lamp replacement indication, and door open indication. In one embodiment, the input device(s) 58 may include a selection switch, a keypad, a keyboard or similar controls that a user can physically, verbally or remotely interface with to provide certain information to the controller 16. As with the controller 16, the user interface 54 may be physically collocated with the housing 18 and/or the controller 16 or located remote from the housing 18 and/or the controller 16. For example, the user interface 54 may be integrated with the housing 18 or the air conditioning unit 5, or the user interface 54 may be located within a home or hotel room as part of an electronic thermostat used to control the air conditioning device 5. Moreover, the user interface 54 may communicate with the controller 16 or one or more other components of the air quality control system 10 via wired or wireless communication links. Other than the user interface 54, the display unit 56 and the selection switch 58, the system 20 is substantially similar to the air quality control system 10 shown in FIG. 2 and are identified in using like reference numerals.

In one embodiment, the controller 16 senses the user input regarding the operating parameters of the air quality control system 10 and adapts the system 10 accordingly. This may include adapting the air quality control system 10 to a state with a particular number of operational germicidal lamps 12 and/or ozone lamps 14 in an ‘ON’ position as necessary for treatment of air inside the air quality control system 10 based at least partly on the source airflow 6. If the ozone and odor levels are determined to exceed identified acceptable limits, the controller 16 may take appropriate action. For example, the controller 16 may turn ON or OFF the desired number of germicidal lamps 12 or ozone lamps 14 depending upon the airflow rate and the residual ozone in the airflow to generate or reduce ozone or ultraviolet radiation. In another instance, the controller 16 may process the information coming from the sensors and cause an alerting system (not shown) to be activated.

By way of example, in one embodiment of the invention, a user may utilize user interface 54 to place the air quality control system 20 into various operating modes. For example, a may place air quality control system 20 into a ‘sleep mode’ at night. In this mode, one or more germicidal lamp(s) 12 may be switched off since the outdoor air influx during the nighttime tends to be minimal. In another example, a user may opt to set the operation of the germicidal lamp(s) 12 to a cyclical or periodical mode as previously explained in connection with the operations of the ozone lamp(s) 14. In yet another example, the user input may represent a selection of a number of germicidal lamps 12 or ozone lamps 14 to be powered ‘ON’ or powered ‘OFF’. In one embodiment the controller 16 operates to maintain the operating environment of air quality control system 10/20 as may be indicated by a user through e.g. user interface 54.

In addition to providing input concerning the environmental management in the air quality control system 20, the user may also command certain operations normally carried out in a manual mode of operation. For example, an operator or user may cause air quality control system 20 to periodically release additional ozone or ultraviolet radiation into the housing 18. Moreover, in another instance, if through air distribution network 8 or upon opening the housing 18, the user smells a foul odor, the user can utilize the user interface 54 to command the controller 16 to switch ‘ON’ additional ozone lamps 14 or germicidal lamps 12.

Further, in yet another embodiment of the invention, the inner surface of the housing 18 may be coated with thermally insulated material with suitable ultraviolet protective or ultraviolet reflective coating. In various embodiments of the invention, the air quality control system 10 may be used vertically or horizontally inside the air airflow cabinets of different types of air conditioning devices such as central air-conditioning systems along with suitable airflow cabinets. The airflow cabinets may include various types of exit and transition ducts.

As such, the air quality control systems 10 or 20 may be a front-open system or a top-open system depending upon the configuration of the air conditioning unit 5 and/or the air distribution network 8. Similarly, the ozone lamp(s) 14 and the germicidal lamp(s) 12 may be positioned vertically (e.g. with the direction of airflow), horizontally (e.g., transverse to the direction of airflow) or at an angled orientation within the housing 18.

In one embodiment of the invention, the housing 18 of the air quality control system 10 may be provided with a door (not shown) to access the ozone lamp(s) 14 or the germicidal lamp(s) 12 or other components inside. The door can have a variety of lengths and widths and can be of a hinged design, with the axis of the hinge occurring either on the side, top or bottom of the door. Furthermore, hinged doors can have a position lock that can keep the door open at a certain position, without the user having to hold it at that position.

In an instance where the door is not made by the manufacturing process of ‘drawing’ and is instead cut and bent into shape using sheet metal, door-seams (not shown) may be sealed in order to prevent leakage. Such door-seams may be sealed using soldering, brazing, internal insulation techniques or by using tape or any other material that does not allow light to pass through. In another instance, a door-lock (not shown) may be used to keep the door shut until a particular event occurs such as the internal temperature of the air quality control system 10 falling below a set-point. In another instance, the door of the air quality control system 10 may be fitted with a door-catch to hold the door tight in a shut position against housing 18. Typically, a solenoid with a return spring and a chamfered plunger may be used as a door-lock. The solenoid may need to be powered in order for the door to be opened, whereas the door-catch may be operated electromagnetically or by a motor driven cam.

In another embodiment of the invention, access to components within the housing 18 such as germicidal lamp(s) 12 and/or ozone lamp(s) 14 can also be obtained through an access panel (not shown) provided on the housing 18. The access panel may be removed from the housing 18 and set aside to gain access to various components within the housing 18. The access panel can be secured in a number of ways including screws, draw latches, magnetic latches or by having hook shaped protrusions on the panel that will slide into a slot on the housing 18.

In one embodiment, the germicidal lamp(s) 12 and the ozone lamp(s) 14 may be mounted on the door, or on the access panel such that when the door or access panel is opened, the lamp(s) is(are) displaced from the inside of the housing 18. In one embodiment, operation of the air quality control system 10 may be prevented while the door or access panel remains in an opened position. A flange on the air quality control system 10 may provide first layer of sealing between the insulation and flange and a C shaped door may provide a secondary seal over the air quality control system 10 surface.

In one embodiment, the air quality control system 10 may include one or more sight glass or view ports (not shown) to allow a user to see the germicidal lamp(s) 12 and the ozone lamp(s) 14 during operation. These sight glasses may be formed in one or multiple layers of glass and they may be provided on the door or the access panel or any other side-wall of the housing 18. Moreover, the sight glasses may be made from a variety of materials such as borosilicate glass, tempered glass, polycarbonate that do not allow the ultraviolet radiation to escape from the housing 18 into the air of the room.

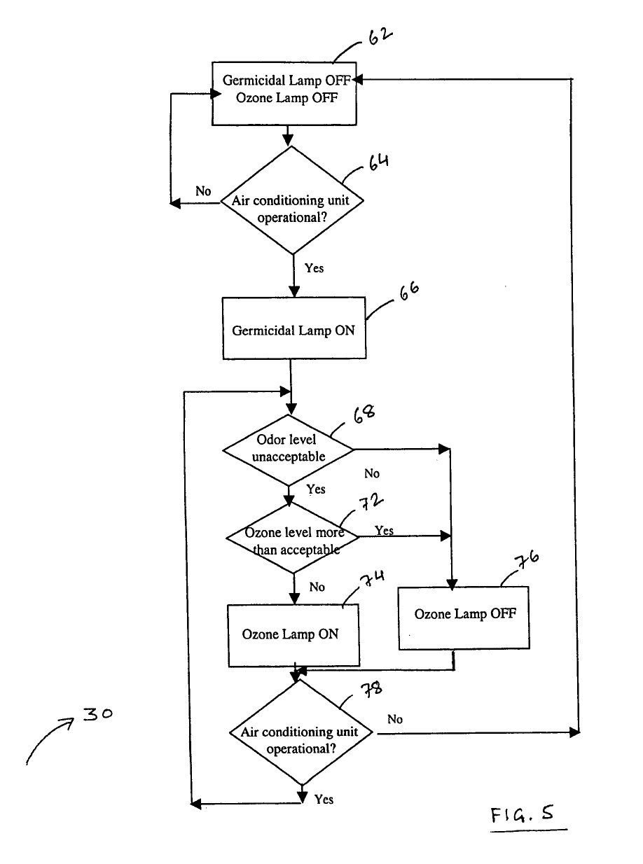

FIG. 5 illustrates a method 30 for controlling air quality in accordance with an exemplary embodiment of the invention. At the start, the germicidal lamp(s) 12 and the ozone generating ultraviolet lamp(s) 14 of the air quality control system 10 are disposed in the path of the source airflow 6 from the air conditioning unit 5. In the default state indicated by block 62, both types of lamps are switched to or reside in an ‘OFF’ state. At block 64, a determination is made as to whether air conditioning unit 5 is operational. In one embodiment, the determination is made based upon whether or not the source airflow 6 has achieved at least a minimum flow rate. In an alternative embodiment, an air switch may be used to determine whether the air conditioning unit 5 is operational. Once it is determined that the air conditioning unit 5 is operational, the germicidal lamp(s) 12 is(are) powered ‘ON’ as indicated in functional block 66 to irradiate ultraviolet radiation. By doing so, fungi, bacteria, viruses and other microbes present in the air may be killed by ultraviolet irradiation from the germicidal lamp(s) 12. Next, a determination may be made as to whether ozone lamp 14 should be powered ‘ON’.

At block 68 of the illustrated method, an odor sensor 26 positioned in the path of source airflow 6 determines the odor level in the source airflow 6 coming out of the air conditioning device 5. In one embodiment, the odor sensor 26 compares the determined odor level with a prescribed range of operation and controls the functioning of the ozone lamp(s) 14 accordingly. If the odor level inside the housing 18 is determined to not exceed a determined odor level, ozone lamp(s) 14 remains ‘OFF’ or is otherwise turned ‘OFF’ as indicated by functional block 76. If it is determined at functional block 68, that the odor level inside the housing 18 does exceed the determined level or range, then a further determination may be made as to whether the ozone level in the housing 18 exceeds a determined level or range at functional block 72. As described above, an ozone sensor 22 may be positioned in the path of source airflow 6 to determine the ozone level in the air coming out of the air conditioning device. In one embodiment, the ozone sensor 22 compares the determined ozone level with a prescribed range of operation and further controls the functioning of the ozone lamp(s) 14. If the ozone level is determined to exceed a determined level or range, the ozone lamp(s) 14 may again be turned ‘OFF’ (or otherwise remain OFF) as indicated by functional block 76. If however, the ozone level is determined to not exceed the acceptable level/range, the ozone lamp(s) is(are) powered ‘ON’ as indicated by functional block 74. It should be noted that, the ozone and odor levels within the housing 18 may be determined sequentially or in parallel operation. Finally, at functional block 78, a determination is made again as to whether air conditioning unit 5 is operational and the method 30 repeats itself from thereon.

It should be noted that the prescribed range of ozone level, odor level and ultraviolet radiation level may include minimum and maximum values. In another instance, instead of a range, one or more independent values may be stipulated. For example, a single value representing only a minimum ozone level (or odor level or ultraviolet radiation level) or a value representing only a maximum ozone level may be provided. Alternatively, a string of values may also be provided indicating, for instance, various levels of action to be taken. For example, one value representing an ozone level (or odor level) may be provided, which when reached, indicates that the system should stop producing ozone.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An air quality control system for use with an air-conditioning unit, the air quality control system comprising:
a housing having an inlet end to receive a source airflow from the air-conditioning unit and an outlet end to provide a sanitized airflow;
at least one germicidal lamp disposed within the housing to generate ultraviolet radiation within the source airflow;
at least one ozone lamp disposed within the housing to generate ozone gas within said source airflow; and
a controller to adaptively control emission of the ultraviolet radiation and ozone gas within said source airflow as a function of at least an operating state of said air conditioning unit,
wherein operation of said air quality control system is electrically and mechanically independent from said air conditioning unit.

2. The system according to claim 1, wherein said at least one germicidal lamp is configured to control airborne pathogen and fungal growth within said source airflow using said ultraviolet radiation.

3. The system according to claim 1, wherein said at least one germicidal lamp is configured to control bacteria, fungi and viruses within said source airflow using said ultraviolet radiation.

4. The system according to claim 1, wherein said at least one germicidal lamp is configured to control mold growth within said source airflow using said ultraviolet radiation.

5. The system according to claim 1, wherein said at least one ozone lamp is configured to control bacteria, fungi and viruses within said source airflow using said ozone gas.

6. The system according to claim 1, wherein said at least one ozone lamp is configured to oxidize a plurality of suspended matter within said source airflow using said ozone gas.

7. The system according to claim 6, wherein said at least one ozone lamp is further configured to control odor within said source airflow using said ozone gas.

8. The system of claim 1, further comprising an air switch disposed within the housing to detect when said source airflow achieves at least a minimum flow rate.

9. The system according to claim 8, wherein said controller is further configured to control operation of said at least one ozone lamp or said at least one germicidal lamp based on an operating state of the air switch.

10. The system according to claim 1, further comprising an ozone sensor to sense an ozone level within said source airflow.

11. The system according to claim 10, wherein said ozone sensor is disposed within the housing and is configured to sense an excess quantity of ozone relative to a determined acceptable quantity of ozone within said source airflow.

12. The system according to claim 11, wherein said controller is configured to control operation of said at least one ozone lamp based on said excess quantity of ozone within said source airflow.

13. The system according to claim 11, wherein said at least one germicidal lamp is further configured to oxidize said excess quantity of ozone into oxygen using said ultraviolet radiation.

14. The system according to claim 13, wherein said ultraviolet radiation comprises ultraviolet radiation with wavelength of 254 nanometers.

15. The system according to claim 1, further comprising an odor sensor disposed within said housing and configured to sense an odor level within said source airflow.

16. The system according to claim 1, further comprising an ultraviolet radiation sensor disposed within said housing and configured to sense a level of said ultraviolet radiation within said source airflow.

17. The system according to claim 1, further comprising at least one sensing device to detect the operating state of said air-conditioning device, the sensing device selected from the group consisting of an air switch, a differential pressure sensor, and combinations thereof.

18. The system according to claim 1, wherein the housing further comprises an access panel or door, wherein said at least one germicidal lamp is coupled to the access panel or door such that operation of said at least one germicidal lamp is prevented while said access panel or door is open.

19. The system according to claim 18, wherein upon said access panel or door being opened, said at least one germicidal lamp is transitioned from a position inside of the housing to a position outside of the housing.

20. The system according to claim 1 further comprising at least one safety feature to facilitate safe operation of said air quality control system, wherein said at least one safety feature is selected from the group of an ozone lamp interlock, a germicidal lamp interlock, a germicidal lamp status indicator, an ozone lamp status indicator, and combinations thereof.

21. An air quality control system comprising:
a user interface to receive user input relating to the control of air quality in said air quality control system;
a housing having an inlet end to receive a source airflow and an outlet end to provide a sanitized airflow;
at least one germicidal lamp coupled to the housing to generate ultraviolet radiation into the source airflow;
at least one ozone lamp coupled to the housing to generate ozone gas into the source airflow;
an ozone sensor coupled to the housing to sense an ozone gas level within the source airflow; and
a controller to adaptively control emission of the ultraviolet radiation and the ozone gas into the source airflow in accordance with said user input and as a function of at least said ozone gas level and the source airflow.

22. The system of claim 21, further comprising an air switch disposed within the housing to detect when said source airflow achieves at least a minimum flow rate.

23. The system according to claim 22, wherein said controller is further configured to control operation of said at least one ozone lamp or said at least one germicidal lamp based on an operating state of the air switch.

24. The system according to claim 21, wherein said ozone sensor is configured to sense an excess quantity of ozone relative to a determined acceptable quantity of ozone within said source airflow.

25. The system according to claim 25, wherein said controller is further configured to control operation of said at least one ozone lamp based on said excess quantity of ozone within said source airflow.

26. The system according to claim 21, further comprising an odor sensor configured to sense an odor level within said source airflow.

27. The system according to claim 21, wherein said user interface is adapted to enable at least one operation selected from the group of operations consisting of initiating a cyclical ozone gas generation mode, initiating a cyclical ultraviolet radiation generation mode, selection of a number of ultraviolet lamps, and combinations thereof.

28. The system according to claim 21, wherein said controller is configured to monitor at least one safety feature to facilitate safe operation of said air quality control system.

29. The system according to claim 21, wherein said at least one safety feature is selected from the group consisting of an ozone lamp interlock, a germicidal lamp interlock, an ozone lamp status indicator, a germicidal lamp status indicator, and combinations thereof.

30. The system according to claim 21, further comprising an ultraviolet radiation sensor coupled to the housing to sense a level of said ultraviolet radiation within said source airflow.

31. The system according to claim 21, wherein the housing further comprises an access panel or door, wherein said at least one germicidal lamp is coupled to the access panel or door such that operation of said at least one germicidal lamp is prevented while said access panel or door is open.

32. The system according to claim 31, wherein upon said access panel or door being opened, said at least one germicidal lamp is transitioned from a position inside of the housing to a position outside of the housing.

33. A method for controlling air quality in a ventilation system including an air-conditioning unit and an air distribution network, the method comprising:
receiving user supplied input relating to the control of air quality within said ventilation system;
determining an operating state of the air conditioning unit;
determining an ozone level within a source airflow generated by said air conditioning unit;
determining an odor level within said source airflow; and
adaptively exposing at least a portion of the source airflow to at least one of an ozone gas and ultraviolet radiation as a function of at least said operating state of the air conditioning unit and said ozone gas level so as to generate a sanitized airflow for provision to the air distribution network in accordance with said user supplied inputs.

34. The method according to claim 33, wherein said determining an operating state of the air conditioning unit comprises using an air switch.

35. The method according to claim 33, wherein determining an ozone level further comprises sensing an excess quantity of ozone relative to a determined acceptable quantity of ozone within said source airflow.

36. The method according to claim 35, wherein adaptively exposing at least a portion of the source airflow to at least one of an ozone gas and ultraviolet radiation comprises controlling said generation of ozone gas based on said excess quantity of ozone within said source airflow.

37. The method according to claim 33, further comprising sensing an odor level within said source airflow.

38. The method according to claim 33, wherein adaptively exposing at least a portion of the source airflow to at least one of an ozone gas and ultraviolet radiation comprises oxidizing a plurality of suspended matter within said source airflow using said ozone gas.

39. A modular air quality control system for use with an air-conditioning unit, the air quality control system comprising:
a housing having an inlet end to receive a source airflow from the air-conditioning unit and an outlet end to provide a sanitized airflow;
a plurality of independently controllable air sanitizing components coupled to the housing; and
a controller to adaptively control which of said plurality of independently controllable air sanitizing components should operate as a function of at least an operating state of said air conditioning unit.

40. The air quality control system of claim 39, wherein operation of said air quality control system is electrically and mechanically independent from that of said air conditioning unit.

41. The air quality control system of claim 40, wherein the controller adaptively controls operation of said air sanitizing components based on characteristics of the source airflow.

42. The air quality control system of claim 41, wherein said characteristics comprise flow rate.

43. The air quality control system of claim 40, wherein the housing is physically coupled to the air conditioning unit.

44. The air quality control system of claim 39, wherein the plurality of independently operable air sanitizing components comprises a plurality of germicidal lamps disposed within the housing to generate ultraviolet radiation within the source airflow.

45. The air quality control system of claim 44, wherein the plurality of independently operable air sanitizing components further comprises at least one ozone lamp disposed within the housing to generate ozone gas within said source airflow.

46. A modular air quality control system for use with an air-conditioning unit, the air quality control system comprising:
a housing having an inlet end to receive a source airflow from the air-conditioning unit and an outlet end to provide a sanitized airflow;
at least one air sanitizing component coupled to the housing; and
a controller to adaptively control operation of said at least one air sanitizing component based on a presence or absence of said source airflow, wherein operation of said air quality control system is electrically and mechanically independent from that of said air conditioning unit.

47. The air quality control system of claim 46, wherein the at least one air sanitizing component is independently controllable.

48. The air quality control system of claim 46, wherein said at least one independently controllable air sanitizing component comprises at least one germicidal lamp disposed within the housing to generate ultraviolet radiation within the source airflow.

49. The air quality control system of claim 48, wherein said at least one independently controllable air sanitizing component further comprises at least one ozone lamp disposed within the housing to generate ozone gas within said source airflow.
